(19) United States
(12) Patent Application Publication
(10) Pub. No.: US 2019/0130144 A1
(43) Pub. Date: May 2, 2019

(54) RADIO FREQUENCY APPARATUS AND RADIO FREQUENCY IDENTIFICATION TAG DETECTION METHOD THEREOF

(71) Applicant: Nyquest Corporation Limited, Hsinchu City (TW)

(72) Inventors: Ying-Jie HUANG, Hsinchu City (TW); Chao-Wen CHI, Hsinchu City (TW); Bang-Jian CHIANG, Hsinchu City (TW)

(73) Assignee: Nyquest Corporation Limited, Hsinchu City (TW)

(21) Appl. No.: 16/093,442

(22) PCT Filed: Apr. 19, 2016
(86) PCT No.: PCT/CN2016/079648

§ 371 Date: Oct. 12, 2018

(51) Int. Cl. G06K 7/10; H04B 5/00; G06K 19/07

(52) U.S. Cl. CPC G06K 7/10366; G06K 19/0723; H04B 5/0062

(57) ABSTRACT

A radio frequency apparatus and a radio frequency identification (RFID) tag detection method are provided. The radio frequency apparatus includes a reader and an RFID tag. The reader includes a first coil and a plurality of second coils. The first coil supports a first frequency band. Each second coil supports a second frequency band. The second frequency band is different from the first frequency band, and the second coils are spaced away from each other and do not overlap each other. The RFID tag includes a first and a second radio frequency circuits which supports the first frequency band and the second frequency band respectively. The first radio frequency circuit can communicate with the first coil by using the first frequency band. The second radio frequency circuit can communicate with at least one of the second coils by using the second frequency band.

### BACKGROUND

### Technical Field

The present invention relates to a radio frequency apparatus and a radio frequency identification (RFID) tag detection method thereof.

### Related Art

RFID is a wireless communications technology, by using which, data can be sent, by modulating a signal to an electromagnetic field with a radio frequency, from a tag that adheres to an article. RFID tags may be classified into passive RFID tags and active RFID tags based on whether an RFID tag has internal power supplying. An internal integrated circuit of the passive RFID tag may be driven by an electromagnetic wave generated by a reader. When signal strength received by a tag is sufficient, the tag can send data to the reader. In the active identification, memory data of an internal tag can be actively transmitted to the reader at any time by using internal electric power.

In daily life, the RFID tag has been widely applied, for example, purchase amount calculation by reading a commodity barcode during a checkout, inventory status confirmation by reading a commodity barcode during warehousing, logistic status confirmation by reading a commodity barcode when a commodity is shipped or put into a warehouse, and luggage classification, and a radio frequency tag is set on a person or an article, is used for inventory and asset tracking and management, and anti-counterfeiting technologies for bank notes and products, and is even implanted into a human body to serve as an identity of a person.

However, the existing RFID tag does not have a function of identifying a tag location. To be specific, during radio frequency communication between the reader and a tag, the reader can only learn whether there is a tag matching the reader, but cannot identify a tag location within a sensing range of the reader.

### SUMMARY

In view of this, an objective of the present invention is to provide a radio frequency apparatus and an RFID tag detection method.

In an embodiment, the radio frequency apparatus includes a reader and an RFID tag. The reader includes a first coil and a plurality of second coils. The first coil supports a first frequency band. Each second coil supports a second frequency band. The second frequency band is different from the first frequency band, and the second coils are spaced away from each other and do not overlap each other. The RFID tag includes a first radio frequency circuit and a second radio frequency circuit. The first radio frequency circuit supports the first frequency band. The first radio frequency circuit can communicate with the first coil by using the first frequency band. The second radio frequency circuit supports the second frequency band. The second radio frequency circuit can communicate with at least one of the second coils by using the second frequency band.

In an embodiment, the first radio frequency circuit is coupled to the second radio frequency circuit, and when the first coil transmits a first radio frequency signal that has the first frequency band, the first radio frequency circuit receives the first radio frequency signal to supply electric power to the second radio frequency circuit, so that the second radio frequency circuit transmits a second radio frequency signal that has the second frequency band, for communication with the at least one of the second coils.

In an embodiment, the first coil is coupled to the second coils, and the first radio frequency circuit transmits a first radio frequency signal that has the first frequency band, for communication with the first coil, to drive the second coils to transmit a second radio frequency signal that has the second frequency band, for communication with the second radio frequency circuit.

In an embodiment, each second coil transmits the second radio frequency signal at a different time point.

In an embodiment, the second frequency band is at least eight times the first frequency band.

In an embodiment, the first frequency band is 125 KHz, and the second frequency band is 13.5 MHz.

In an embodiment, the radio frequency apparatus further includes a processing unit, coupled to the second coils, where the processing unit detects a current, a frequency, a phase, or a cross-voltage of each second coil.

In an embodiment, an RFID tag detection method includes: disposing a first coil, where the first coil supports a first frequency band; disposing a plurality of second coils, where the second coils support a second frequency band, the second frequency band is different from the first frequency band, and the second coils are spaced away from each other and do not overlap each other; communicating, by a first radio frequency circuit of an RFID tag, with the first coil by using the first frequency band; and communicating, by a second radio frequency circuit of the RFID tag, with at least one of the second coils by using the second frequency band.

In an embodiment, the step of communicating with the first coil by using the first frequency band is transmitting, by the first coil, a first radio frequency signal that has the first frequency band, for communication with the first radio frequency circuit; and the step of communicating with at least one of the second coils by using the second frequency band includes: coupling the first radio frequency circuit to the second radio frequency circuit; and receiving, by the first radio frequency circuit, the first radio frequency signal to supply electric power to the second radio frequency circuit, so that the second radio frequency circuit transmits a second radio frequency signal that has the second frequency band, for communication with the at least one of the second coils.

In an embodiment, the step of communicating with the first coil by using the first frequency band is transmitting, by the first radio frequency circuit, a first radio frequency signal that has the first frequency band, for communication with the first coil; and the step of communicating with at least one of the second coils by using the second frequency band includes: coupling the first coil to the second coils; and receiving, by the first coil, the first radio frequency signal, to drive the second coils to transmit a second radio frequency signal that has the second frequency band, for communication with the second radio frequency circuit.

In summary, according to the embodiments of the radio frequency apparatus in the present invention, the reader includes the two coils that support the different frequency bands, and the RFID tag includes the two radio frequency circuits that support the different frequency bands, so that the RFID tag can perform radio frequency communication with the reader by using the two frequency bands, and location information of the RFID tag is identified.

### BRIEF DESCRIPTION OF THE DRAWINGS

FIG. 1 is a schematic diagram of an embodiment of a radio frequency apparatus according to the present invention;

FIG. 2 is a schematic diagram of an implementation of a reader and an RFID tag in FIG. 1;

FIG. 3 is a schematic diagram of an operating manner of a first embodiment of the reader and the RFID tag in FIG. 2;

FIG. 4 is a schematic diagram of an operating manner of a second embodiment of the reader and the RFID tag in FIG. 2; and

FIG. 5 is a schematic diagram of an implementation of application of a radio frequency apparatus according to the present invention.

### DETAILED DESCRIPTION

The following describes a structural principle and a work principle of the present invention in detail with reference to the accompanying drawings:

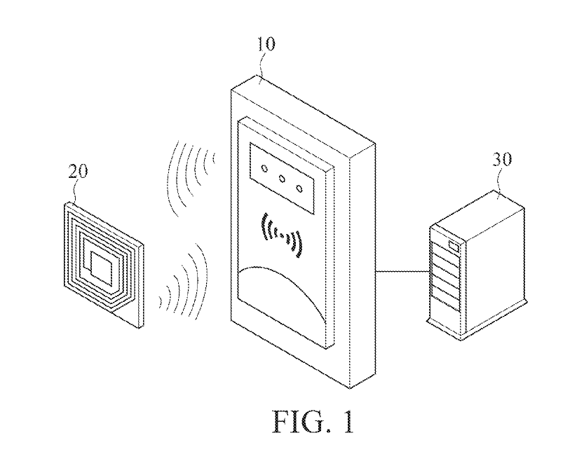

FIG. 1 is a schematic diagram of an embodiment of a radio frequency apparatus according to the present invention. Referring to FIG. 1, the radio frequency apparatus includes a reader 10 and an RFID tag 20, and the reader 10 communicates with the RFID tag 20 by using a radio frequency signal (or referred to as a radio signal).

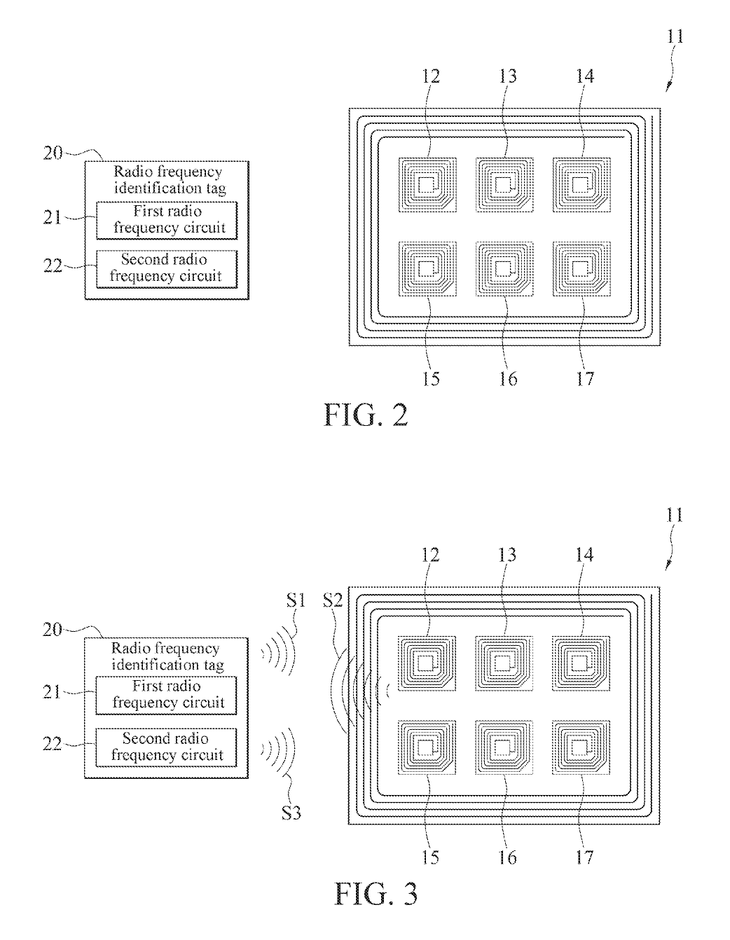

FIG. 2 is a schematic diagram of an implementation of a reader 10 and an RFID tag 20 in FIG. 1. Referring to FIG. 2, a first coil 11 and a plurality of second coils are disposed in the reader 10, the first coil 11 supports a first frequency band and can receive and transmit a radio frequency signal that has the first frequency band, and each second coil supports a second frequency band and can receive and transmit a radio frequency signal that has the second frequency band. As shown in FIG. 2, using six second coils as an example (for the convenience of description, the six second coils are respectively referred to as second coils 12, 13, 14, 15, 16, and 17), and the second coils 12 to 17 are spaced away from each other and do not overlap each other. In some implementations, the second coils 12 to 17 may be located on a same horizontal surface and disposed in the center of the first coil 11.

The RFID tag 20 supports the first frequency band and the second frequency band, and the RFID tag 20 can separately communicate with the first coil 11 and the second coils 12 to 17. As shown in FIG. 2, the RFID tag 20 includes a first radio frequency circuit 21 and a second radio frequency circuit 22. The first radio frequency circuit 21 can perform radio frequency communication with the first coil 11 by using the first frequency band. The second radio frequency circuit 22 can perform radio frequency communication with at least one of the six second coils 12 to 17 by using the second frequency band.

To avoid mutual interference between radio frequency signals, the first frequency band and the second frequency band that are used for mutual communication between the reader 10 and the RFID tag 20 are different from each other. In some implementations, the first frequency band may be a low frequency band, for example, 125 KHz, and the second frequency band may be a medium-high frequency band or a band with an ultra-high frequency (UHF) or above, for example, 13.5 MHz, which is different from the low frequency band. Based on this, using an example in which the first coil 11 supports the low frequency band and the second coils 12 to 17 support the medium-high frequency band or the band with the UHF or above, as shown in FIG. 2, the first coil 11 is a large-sized coil, and the second coils 12 to 17 are small-sized coils. Therefore, in the radio frequency apparatus, a quantity of large-sized coils is less than a quantity of small-sized coils, so that manufacturing costs of the radio frequency apparatus can be reduced. It should be understood that, a proportion of the first coil 11 to the second coils 12 to 17 drawn in FIG. 2 is only exemplary. Preferably, the second frequency band is at least eight times the first frequency band.

Alternatively, in some other implementations, the second frequency band may be a low frequency band, and in this case, the second coils 12 to 17 are large-sized coils; and the first frequency band may be the medium-high frequency band or the band with the UHF or above, which is different from the low frequency band, and in this case, the first coil 11 is a small-sized coil.

In some implementations, the two radio frequency circuits 21 and 22 include antennas, encoding modules, and decoding modules, to receive and transmit radio frequency signals and perform signal processing on the radio frequency signals.

Next, using an example in which the first frequency band is 125 KHz and the second frequency band is 13.5 MHz, the following describes operating manners of the reader 10 and the RFID tag 20 by using two embodiments.

FIG. 3 is a schematic diagram of an operating manner of a first embodiment of the reader 10 and the RFID tag 20 in FIG. 2. Referring to FIG. 3, in the first embodiment, the RFID tag 20 is an active tag. The first radio frequency circuit 21 first transmits a first radio frequency signal S1 whose frequency is 125 KHz, for communication with the first coil 11. If the reader 10 is within a magnetic field range of the first radio frequency signal S1, the first coil 11 of the reader 10 receives the first radio frequency signal S1. In this embodiment, the first coil 11 is coupled to the second coils 12 to 17, the first coil 11 transmits an induction current generated by the first radio frequency signal S1 to the second coils 12 to 17, to drive the second coils 12 to 17 to transmit a second radio frequency signal S2, for communication with the second radio frequency circuit 22, to detect the RFID tag 20. A frequency of the second radio frequency signal S2 is not equal to a frequency of the first radio frequency signal S1, and the frequency of the second radio frequency signal S2 is 13.5 MHz. Next, if the RFID tag 20 is within a magnetic field range of the second radio frequency signal S2, the second radio frequency circuit 22 of the RFID tag 20 receives the second radio frequency signal S2.

In some implementations, the first radio frequency signal S1 may include an apparatus identification code of the RFID tag 20 or various other to-be-sent information.

Further, to distinguish the second radio frequency signal S2 transmitted by the plurality of second coils 12 to 17, each of the second coils 12 to 17 may transmit the second radio frequency signal S2 at a different time point. In other words, at a same time point, one of the plurality of second coils 12 to 17 transmits the second radio frequency signal S2. For example, the second coils 12 to 17 may transmit the second radio frequency signal S2 based on a sequence of locations of the second coils 12 to 17, to be specific, transmit the second radio frequency signal S2 based on a sequence of the second coil 12, the second coil 13, the second coil 14, the second coil 15, the second coil 16, and the second coil 17.

After the second coils 12 to 17 transmit the second radio frequency signal S2, the RFID tag 20 receives the second radio frequency signal S2 transmitted by an adjacent second coil in the second coils 12 to 17. For example, if the RFID tag 20 is adjacent to one second coil, such as the second coil 12, the second radio frequency signal S2 received by the second radio frequency circuit 22 is from the second coil 12; or if the RFID tag 20 is adjacent to two second coils, such as the second coil 14 and the second coil 15, the second radio frequency signal S2 received by the second radio frequency circuit 22 is from the second coil 14 and the second coil 15.

After the second radio frequency circuit 22 receives the second radio frequency signal S2, in some implementations, the second radio frequency circuit 22 may further transmit a third radio frequency signal S3, and a frequency of the third radio frequency signal S3 is 13.5 MHz. In this case, a coil within a magnetic field range of the third radio frequency signal S3 may receive the third radio frequency signal S3. For example, if the RFID tag 20 is adjacent to one second coil, such as the second coil 12, the second coil 12 receives the third radio frequency signal S3, and in this case, second coils 13 to 17 do not receive the third radio frequency signal S3; or if the RFID tag 20 is adjacent to two second coils, such as second coils 15 and 16, the second coils 15 and 16 receive the third radio frequency signal S3, and second coils 12, 13, 14, and 17 do not receive the third radio frequency signal S3. The rest can be deduced by analogy, and details are not described again.

Based on this, as shown in FIG. 1, the radio frequency apparatus may further include a processing unit 30, coupled to each of the second coils 12 to 17. The processing unit 30 detects a current, a frequency, a phase, or a cross-voltage of each of the second coils 12 to 17, to generate a detection result to represent location information of the RFID tag 20. In other words, the processing unit 30 can identify a second coil in the second coils 12 to 17 that is adjacent to the RFID tag 20. For example, using cross-voltage detection as an example, when a cross-voltage of the second coil 16 changes and cross-voltages of the second coils 12, 13, 14, 15, and 17 do not change, it indicates that the RFID tag 20 is adjacent to the second coil 16; or if the RFID tag 20 moves from the second coil 16 towards the second coil 17, causing cross-voltages of the second coils 16 and 17 to simultaneously change, and cross-voltages of the second coils 12, 13, 14, and 15 do not change, it indicates that the RFID tag 20 is adjacent to the second coils 16 and 17. The rest can be deduced by analogy, and details are not described again. If locations of the RFID tag 20 relative to the plurality of second coils 12 to 17 do not change, the third radio frequency signal S3 received by the second radio frequency circuit 22 is from a same second coil.

In some embodiments, the processing unit 30 may be a central processing unit, a microcontroller, or a microprocessor, and the processing unit 30 may be disposed in a personal computer or a server, or disposed in the reader 10. The present invention is not limited thereto.

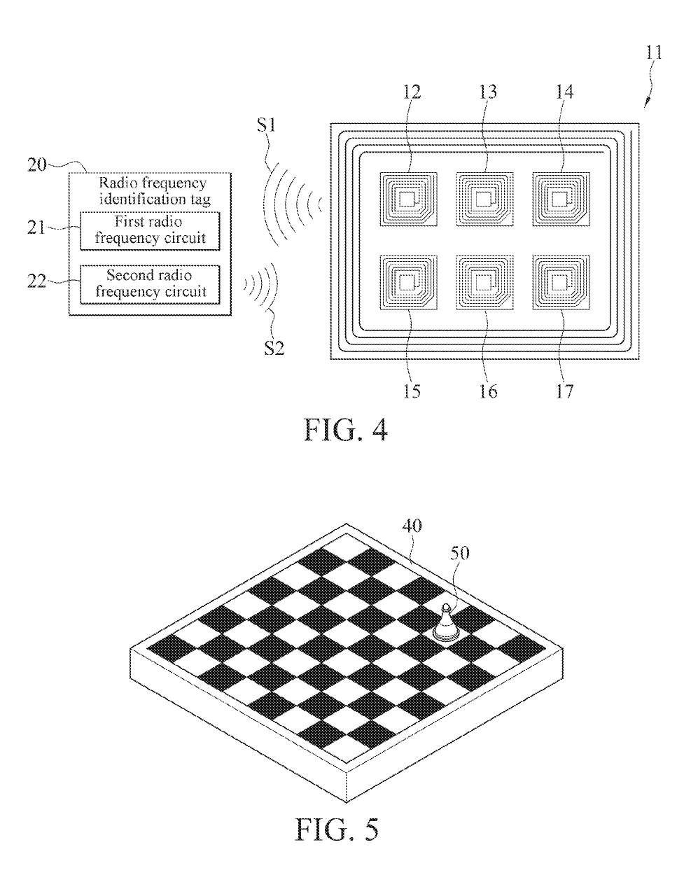

FIG. 4 is a schematic diagram of an operating manner of a second embodiment of the reader 10 and the RFID tag 20 in FIG. 2. Referring to FIG. 4, in the second embodiment, the RFID tag 20 is a passive tag. The first coil 11 of the reader 10 first transmits the first radio frequency signal S1 whose frequency is 125 KHz, for communication with the first radio frequency circuit 21. If the RFID tag 20 is within a magnetic field range of the first radio frequency signal S1, the first radio frequency circuit 21 of the RFID tag 20 receives the first radio frequency signal S1 to generate an induction current. In this embodiment, the second radio frequency circuit 22 is coupled to the first radio frequency circuit 21. The second radio frequency circuit 22 receives, from the first radio frequency circuit 21, the induction current generated based on the first radio frequency signal S1, to obtain electric power to transmit the second radio frequency signal S2. A frequency of the second radio frequency signal S2 is not equal to a frequency of the first radio frequency signal S1, and the frequency of the second radio frequency signal S2 is 13.5 MHz. Next, if the reader 10 is within a magnetic field range of the second radio frequency signal S2, the second coils 12 to 17 of the reader 10 receive the second radio frequency signal S2, to generate the foregoing detection result.

Further, a coil within a magnetic field range of the second radio frequency signal S2 can receive the second radio frequency signal S2. For example, if the RFID tag 20 is adjacent to one second coil, such as the second coil 17, the second coil 17 receives the second radio frequency signal S2, and in this case, second coils 12 to 16 do not receive the second radio frequency signal S2; or if the RFID tag 20 is adjacent to two second coils, such as second coils 13 and 16, the second coils 13 and 16 receive the second radio frequency signal S2, and second coils 12, 14, 15, and 17 do not receive the second radio frequency signal S2. The rest can be deduced by analogy, and details are not described again. In this embodiment, the processing unit 30 may alternatively detect, in real time, whether a current, a frequency, a phase, or a cross-voltage of each of the second coils 12 to 17 changes, to identify location information of the RFID tag 20.

In application, as shown in FIG. 5, the reader 10 may be a chessboard 40, and the RFID tag 20 may be at least one chess piece 50. The chessboard 40 can identify a location of the chess piece 50 by using a plurality of second coils, to perform various chess games, for example, the game of go, western chess, Chinese chess, and Chinese checkers.

In summary, according to the embodiments of the radio frequency apparatus in the present invention, the reader includes the two coils that support the different frequency bands, and the RFID tag includes the two radio frequency circuits that support the different frequency bands, so that the RFID tag can perform radio frequency communication with the reader by using the two frequency bands, and location information of the RFID tag is identified.

Although the present invention is disclosed above by using the embodiments, the embodiments are not used for limiting the present invention. Any person of ordinary skill in the art may make some changes and modifications without departing from the spirit and scope of the present invention. Therefore, the protection scope of the present invention shall be subjected to the scope defined in the claims.

1. A radio frequency apparatus, comprising:
a reader, comprising a first coil and a plurality of second coils, wherein the first coil supports a first frequency band, the second coils support a second frequency band, the second frequency band is different from the first frequency band, and the second coils are spaced away from each other and do not overlap each other; and
a radio frequency identification (RFID) tag, comprising a first radio frequency circuit and a second radio frequency circuit, wherein the first radio frequency circuit supports the first frequency band, the second radio frequency circuit supports the second frequency band, the first radio frequency circuit can communicate with the first coil by using the first frequency band, and the second radio frequency circuit can communicate with at least one of the second coils by using the second frequency band.

2. The radio frequency apparatus according to claim 1, wherein the first radio frequency circuit is coupled to the second radio frequency circuit, and when the first coil transmits a first radio frequency signal that has the first frequency band, the first radio frequency circuit receives the first radio frequency signal to supply electric power to the second radio frequency circuit, so that the second radio frequency circuit transmits a second radio frequency signal that has the second frequency band, for communication with the at least one of the second coils.

3. The radio frequency apparatus according to claim 2, further comprising a processing unit, coupled to the second coils, wherein the processing unit detects a current, a frequency, a phase, or a cross-voltage of each second coil.

4. The radio frequency apparatus according to claim 2, wherein the second frequency band is at least eight times the first frequency band.

5. The radio frequency apparatus according to claim 2, wherein the first frequency band is 125 KHz, and the second frequency band is 13.5 MHz.

6. The radio frequency apparatus according to claim 1, wherein the first coil is coupled to the second coils, and the first radio frequency circuit transmits a first radio frequency signal that has the first frequency band, for communication with the first coil, to drive the second coils to transmit a second radio frequency signal that has the second frequency band, for communication with the second radio frequency circuit.

7. The radio frequency apparatus according to claim 6, wherein each second coil transmits the second radio frequency signal at a different time point.

8. The radio frequency apparatus according to claim 7, further comprising a processing unit, coupled to the second coils, wherein the processing unit detects a current, a frequency, a phase, or a cross-voltage of each second coil.

9. The radio frequency apparatus according to claim 7, wherein the second frequency band is at least eight times the first frequency band.

10. The radio frequency apparatus according to claim 7, wherein the first frequency band is 125 KHz, and the second frequency band is 13.5 MHz.

11. A radio frequency identification (RFID) tag detection method, comprising:
disposing a first coil on a reader, wherein the first coil supports a first frequency band;
disposing a plurality of second coils on the reader, wherein the second coils support a second frequency band, the second frequency band is different from the first frequency band, and the second coils are spaced away from each other and do not overlap each other;
communicating, by a first radio frequency circuit of an RFID tag, with the first coil by using the first frequency band; and
communicating, by a second radio frequency circuit of the RFID tag, with at least one of the second coils by using the second frequency band.

12. The RFID tag detection method according to claim 11, wherein the step of communicating with the first coil by using the first frequency band is transmitting, by the first coil, a first radio frequency signal that has the first frequency band, for communication with the first radio frequency circuit; and the step of communicating with at least one of the second coils by using the second frequency band comprises:
coupling the first radio frequency circuit to the second radio frequency circuit; and
receiving, by the first radio frequency circuit, the first radio frequency signal to supply electric power to the second radio frequency circuit, so that the second radio frequency circuit transmits a second radio frequency signal that has the second frequency band, for communication with the at least one of the second coils.

13. The RFID tag detection method according to claim 11, wherein the step of communicating with the first coil by using the first frequency band is, transmitting, by the first radio frequency circuit, a first radio frequency signal that has the first frequency band, for communication with the first coil; and the step of communicating with at least one of the second coils by using the second frequency band comprises:
coupling the first coil to the second coils; and
receiving, by the first coil, the first radio frequency signal, to drive the second coils to transmit a second radio frequency signal that has the second frequency band, for communication with the second radio frequency circuit.
